(19) United States
(12) Patent Application Publication
(10) Pub. No.: US 2024/0322448 A1
(43) Pub. Date: Sep. 26, 2024

(54) THIN SHEET-LIKE ANTENNA FOR NARROWBAND VEHICULAR COMMUNICATION

(71) Applicant: FORD GLOBAL TECHNOLOGIES, LLC, DEARBORN, MI (US)

(72) Inventor: Eric Newsom, Frankenmuth, MI (US)

(21) Appl. No.: 18/678,291

(22) Filed: May 30, 2024

Related U.S. Application Data
(63) Continuation-in-part of application No. 18/100,105, filed on Jan. 23, 2023.

(51) Int. Cl. H01Q 21/06; H01Q 1/24; H01Q 5/48

(52) U.S. Cl. CPC H01Q 21/062; H01Q 1/241; H01Q 5/48

(57) ABSTRACT

An antenna adapted for receiving satellite signals (e.g., GNSS or SDARS) includes a first dielectric substrate having a conductive ground plane layer on a lower surface. A second dielectric substrate is juxtaposed with an upper surface of the first dielectric substrate, wherein first and second spiral antenna elements are interposed on an upper surface of the second dielectric substrate, and wherein the first and second spiral antenna elements each have respective origination ends separated by a gap. A plurality of conductive patches are disposed in an array on at least one of the first or second dielectric substrates between the upper surface of the first dielectric substrate and a lower surface of the second dielectric substrate. A plurality of conductive vias extend through the first dielectric substrate connecting the conductive patches to the ground plane layer. First and second RF transmission lines are respectively coupled to the origination ends.

### CROSS REFERENCE TO RELATED APPLICATIONS

This application is a continuation-in-part of co-pending U.S. application Ser. No. 18/100,105, filed Jan. 23, 2023, entitled “Thin Sheet-Like Antenna for Narrowband Vehicular Communication,” which is incorporated herein by reference.

### STATEMENT REGARDING FEDERALLY SPONSORED RESEARCH

Not Applicable.

### BACKGROUND OF THE INVENTION

The present invention relates in general to planar antenna structures for mounting on vehicles, and, more specifically, to a narrowband antenna providing a thin, conformal unit with a radiation pattern oriented orthogonal to the plane of the antenna. The antenna may comprise a spiral radiator adapted for use in reception of RF transmissions from satellites such an in a satellite digital audio radio service (SDARS) or global navigation satellite system (GNSS) reception.

Wireless communication is becoming increasingly important in the operation of transportation vehicles such as cars and trucks. In particular, advanced driver assistance systems and autonomous vehicle systems may utilize wireless communication with nearby vehicles, roadside transceivers, remote base stations, and satellites. Thus, antenna systems represent a significant impact on parts cost, manufacturing/assembly cost, and packaging cost.

Some antennas have been formed as metal traces on the windows of the vehicle, and although on-glass antennas conform to the surface of the vehicle they have provided limited performance (e.g., poor directionality) and are not capable of being used for all of the various radio services. Other types of antenna elements such as masts or “shark fin” antennas which protrude from the surface and can detract from the look of a vehicle. Moreover, they may be subject to damage from being struck by other objects (e.g., in a car wash). The designs, shape, size, and placement of various antennas may be dictated by aspects of the radio signal properties of the respective wireless service to be transmitted.

Various standards have been adopted for many of the wireless services being used in intelligent vehicular transportation systems. Vehicle-to-Everything (V2X) systems refers to any wireless communications which may involve a vehicle. V2X includes vehicle-to-vehicle (V2V) communication where vehicles share information with each other, vehicle-to-infrastructure (V2I) communication where vehicles share information with the infrastructure, vehicle-to pedestrian (V2P) communication where vehicles and/or the infrastructure share information with other travelers. One important type of V2X system for intelligent transportation is the Cellular Vehicle-to-Everything (C-V2X) standard, which may typically operate at 5.9 GHz (e.g., a spectrum of 5.850 GHz to 5.925 GHZ).

In a C-V2X application, signals propagate to and from the vehicle generally horizontally (e.g., by line of sight). In view of the wavelengths of the signals, conventional antenna structures have had a horizontal thickness of 25 millimeters or more, which is undesirable for placement on vertical vehicular surfaces (e.g., front grille, windows, or rear tailgate) for styling and other reasons because of the protrusion. Placement on a horizontal roof is undesirable for the same reasons and because the presence of a sheet metal panel of the roof causes the main direction of propagation to reflect upward (e.g., by 20°) thereby reducing the horizontal performance.

Thus, it would be advantageous to provide a compact antenna which is conformal to a vehicular surface (i.e., has thin, low-profile form factor), which is effective over a relatively narrow bandwidth (e.g., the 5.9 GHz band for C-V2X), and which can be mounted on any type of metal or nonmetal surface on the exterior (vertical or horizontal) of a vehicle.

Other applications of vehicle wireless communication include the reception of signals propagating more vertically, such as satellite reception for global navigation satellite systems (GNSS) including GPS and for digital audio services including SDARS. It would likewise be advantageous to provide a compact antenna which is conformal to a vehicle surface and which is effective over GNSS frequencies (e.g., 1575.42 MHz for GPS) or SDARS frequencies (e.g., 2320 to 2345 MHZ). It would further be advantageous to reduce the size (e.g., thickness) of a satellite antenna so that they can be integrated onto a vehicle in optimal locations on the vehicle exterior, thereby increasing antenna performance, reducing signal errors, and improving accuracy of determining vehicle location.

### SUMMARY OF THE INVENTION

In one aspect of the invention, an antenna adapted for receiving global navigation satellite signals includes a first dielectric substrate having a conductive ground plane layer on a lower surface of the first dielectric substrate. A second dielectric substrate is juxtaposed with an upper surface of the first dielectric substrate, wherein first and second spiral antenna elements are interposed on an upper surface of the second dielectric substrate, and wherein the first and second spiral antenna elements each have respective origination ends separated by a gap. A plurality of conductive patches are disposed in an array on at least one of the first dielectric substrate or the second dielectric substrate between the upper surface of the first dielectric substrate and a lower surface of the second dielectric substrate. A plurality of conductive vias through the first dielectric substrate connect the conductive patches to the ground plane layer. First and second RF transmission lines are respectively coupled to the origination ends.

### BRIEF DESCRIPTION OF THE DRAWINGS

FIG. 1 is a perspective view of an antenna according to an embodiment of the invention.

FIG. 2 is a partially exploded view of the antenna of FIG. 1.

FIG. 3 is a partially exploded view of a meta-material portion of the antenna shown in FIG. 2.

FIG. 4 is a partially exploded view showing the antenna of FIG. 1 with an overwrap and a subminiature connector.

FIG. 5 is a side, cross-sectional view of a region of the antenna at the dipole antenna elements.

FIG. 6 is a perspective view of the dipole antenna elements and connections.

FIG. 7 is a side view of the elements shown in FIG. 6.

FIG. 8 is a top view of a vehicle with an exterior surface carrying an antenna according to the present invention.

FIG. 9 is a schematic diagram showing an antenna radiation pattern for an antenna mounted on a rear, vertical surface of a vehicle.

FIG. 10 is an exploded, perspective view of an embodiment of a GNSS antenna.

FIG. 11 is a top view of the antenna of FIG. 10.

FIG. 12 is a side cross-sectional view of the antenna of FIG. 10.

FIG. 13 is a plan view of the spiral antenna elements of the antenna of FIG. 10.

FIG. 14 is a plan view of the upper dielectric substrate of the antenna of FIG. 10.

FIG. 15 is a plan view of the conductive patches of the antenna of FIG. 10.

FIG. 16 is a plan view of the lower dielectric substrate of the antenna of FIG. 10.

FIG. 17 is a plan view of the ground plane layer of the antenna of FIG. 10.

### DETAILED DESCRIPTION OF PREFERRED EMBODIMENTS

A tuned antenna according to a preferred embodiment of the invention employs a meta-material which is a dielectric board with one side completely metalized and acting as the ground plane and the other side having a periodic array of square patches. A via located at the center of each of these patches connects the patch to the ground plane. The resulting periodic structure of “mushrooms” act as a high impedance surface that suppresses RF currents over a select narrow frequency band and which does not undergo any 180° phase flip in reflections. The size and shape of the patches, the size and shape of the vias, and thickness of the dielectric are all designed to resonate at the frequency of interest (e.g., 5.9 GHZ). The capacitance of the patches need to be balanced with the inductance of the dielectric thickness, which can be chosen to correspond with commercial, off-the-shelf laminates (e.g., RT/Duroid® 5880 laminate available from Rogers Corporation of Chandler, Arizona). On top of the meta-material surface an additional substrate is provided with dipole antenna elements formed as a top layer (tuned to the meta-material and configured to meet the gain and impedance requirements of the antenna). In particular, the dipole is configured to obtain excellent horizonal gain performance.

As a result, a thin planar antenna is obtained which is so thin that it can be integrated as an applique for placement onto a surface of a vehicle essentially as a sticker. The antenna can easily be placed on a vertical surface (e.g., tailgate, grilles, fenders, liftgates, windows) without negatively impacting the esthetic appearance of the vehicle, while also optimizing the directionality of the antenna (e.g., horizontal to the road surface). The applique may include an adhesive backing to allow for integration on any surface. The vehicle surface can be any material (conductive or nonconductive) since the laminated antenna includes its own ground plane.

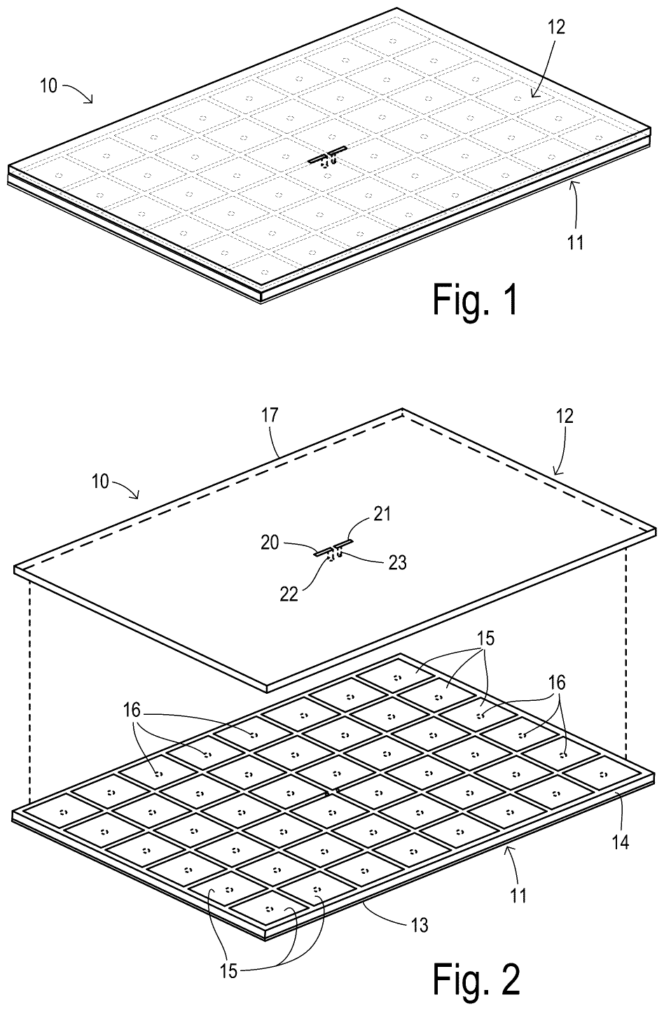

Referring to FIGS. 1 and 2, a laminated antenna structure 10 has a first substrate 11 and a second substrate 12 which is juxtaposed on first substrate 11. A conductive ground plane layer 13 is provided on a lower surface of a first dielectric layer 14. A plurality of conductive patches 15 form an array disposed across an upper surface of first dielectric layer 14. A plurality of conductive vias 16 extend through first dielectric layer, each connecting a respective one of conductive patches 15 to ground plane layer 13. Second substrate 12 has a second dielectric layer 17 without any conductive layer on its lower surface so that it can rest against the upper surface of first substrate 11. First and second dipole antenna elements 20 and 21 disposed on an upper surface of second dielectric layer 17. A signal via 22 connects to first dipole antenna element 20 and passes through substrates 11 and 12 to make available an antenna feed. A grounding via 23 passes through substrates 11 and 12 to connect second dipole antenna element 21 to ground plane layer 13. Vias 22 and 23 may each include two halves which are axially aligned in dielectric layers 14 and 17 and which are located in a gap between conductive patches 15. Consequently, first and second dipole antenna elements 20 and 21 are also aligned with the gap.

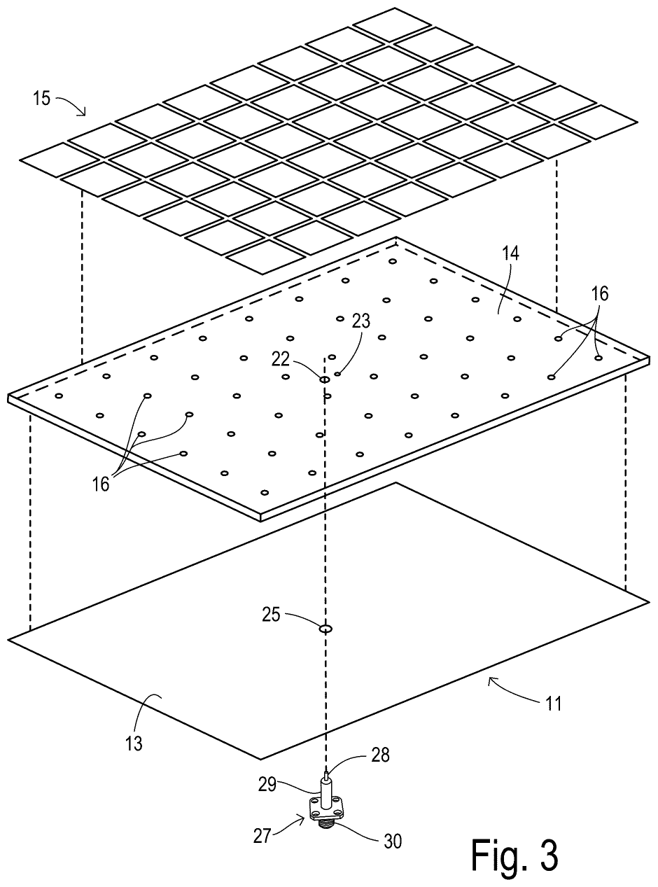

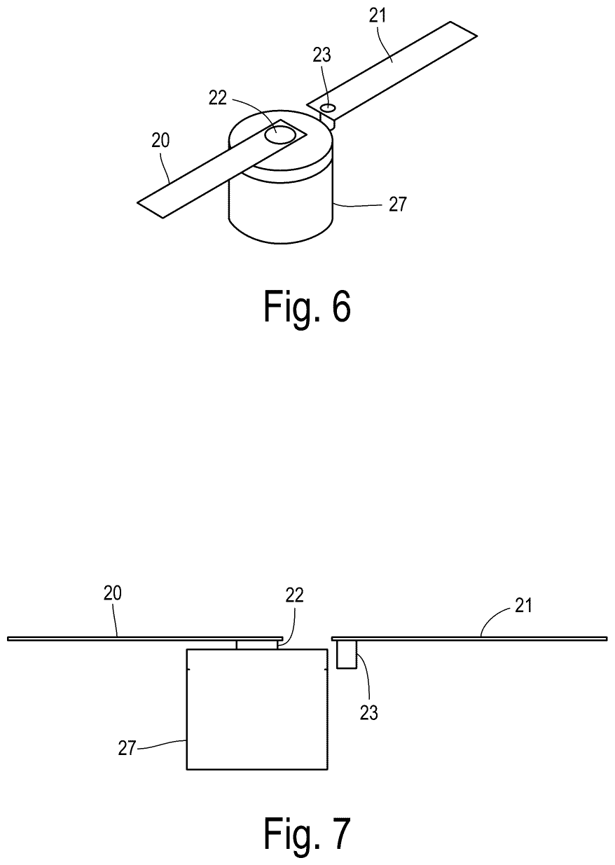

FIG. 3 shows an exploded view of substrate 11, revealing the lower halves of vias 22 and 23. An opening 25 is provided in ground plane layer 13 for accessing signal via 22. A coaxial connector body 27 has a signal conductor 28 for connecting to first dipole antenna element 20 through signal via 22. Connector body 27 a shield conductor portion 29 for connecting to second dipole antenna element 21 and/or ground plane layer 13. A subminiature female socket on connector body 27 is adapted to connect with a coaxial transmission cable to feed antenna signals to a transceiver in the vehicle. The arrangement of dipole antenna elements 20 and 21, connector body 27, and vias 22 and 23 are shown in greater detail in FIGS. 5-7.

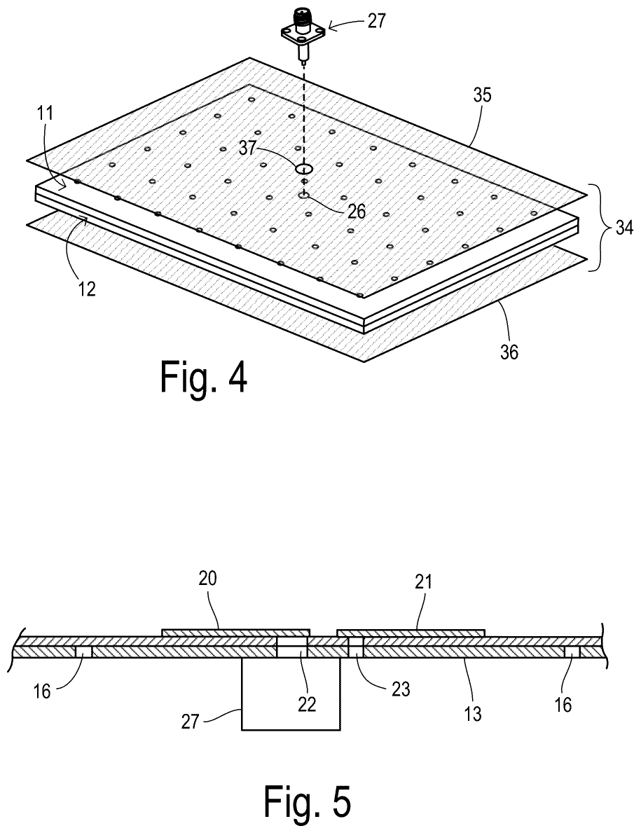

FIG. 4 shows an overwrap 34 comprised of thin, flexible sheets 35 and 36 for enclosing substrates 11 and 12. Preferably, sheet 35 is a backing sheet coated with an adhesive on an outer surface for applying as an applique on an exterior vehicle surface. The inner surfaces of sheets 35 and 36 may also include adhesive for joining as an integrated unit. Sheets 35 and 36 may comprise thermoplastic or other vehicular trim material which can be colored or decorated for styling purposes. Sheet 35 includes an aperture 37 for accommodating coaxial connector body 27 and/or a transmission cable or other signal feed exiting the antenna.

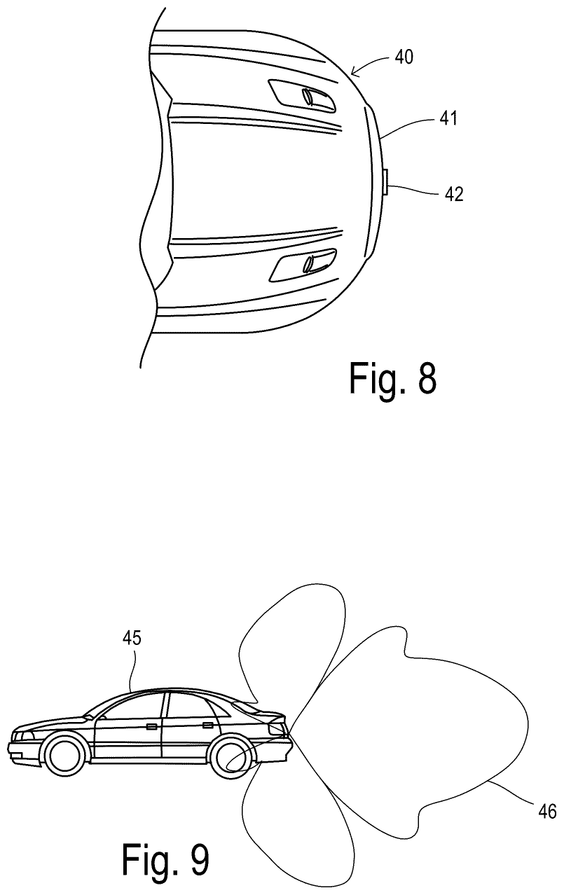

FIG. 8 shows a vehicle 40 have a vertical exterior surface 41 (e.g., a front grille) carrying an antenna 42 formed as an applique according to the above embodiments. Using the disclosed features, antenna 42 can be constructed having a total thickness (i.e., standoff from the vehicle surface) of less than 1 millimeter. By using thin laminated substrates (e.g., PTFE dielectric material with thin copper coating), a flexible applique is obtained which can conform to curved vehicle surfaces. FIG. 9 shows another vehicle 45 with an antenna mounted to a rearward facing vertical surface, such as a rear bumper. By enabling placement on a vertical surface and by configuring the planar antenna with a radiation pattern directed perpendicular to the plane of the antenna, an optimally horizontal radiation pattern 46 is obtained.

To adapt an antenna of the invention to operating at a 5.9 GHz band, the following dimensions have been demonstrated. Rogers 5880 dielectric layers were used for both substrates with a rectangular shape. The length of one side of the sheets may be in a range from about 5 to 6 inches, and the length of the other side may be in a range from about 4 to 4.5 inches (e.g., preferred dimensions of about 5.5 inches by 4.15 inches). The meta-material substrate had a thickness of 0.020 inches (including attached copper layers for the ground plane and patches) and the dipole antenna substrate had a thickness of 0.010 inches. For use at 5.9 GHZ, the dielectric thickness should be less than or equal to 1 millimeter. An 8 by 6 array on the meta-material substrate was comprised of square patches with each edge in a range of from 0.5 to 0.8 inches (e.g., about 0.629 inches). For operation in the 5.9 GHz band, a square for each patch should be less than or equal to 1 inch. A gap between adjacent patches in preferably in a range from about 0.06 to 0.1 inches. The conductive vias between the patches and the ground plane layer had a radius of 0.010 inches, with a preferred range of 0.05 to 0.15 inches.

To fabricate an antenna, laminated dielectric layers which are initially provided with through-holes at positions specified for the vias and then cladded on both sides with copper which can be etched as needed. Alternatively, vias can be drilled and filled at a later time when the etching is performed. A lower side of the lower dielectric (meta-material) is etched only for an aperture for the antenna feed. The upper side of the lower dielectric is etched to form the conductive patches so as to place the vias at their geometric centers. For the upper dielectric (dipole antenna), copper cladding is completely etched away on the lower side, and the dipole antenna elements are etched on the upper side. After attaching a coaxial connector, the unit can be covered with an overwrap with the desired characteristics for integrating with a vehicle.

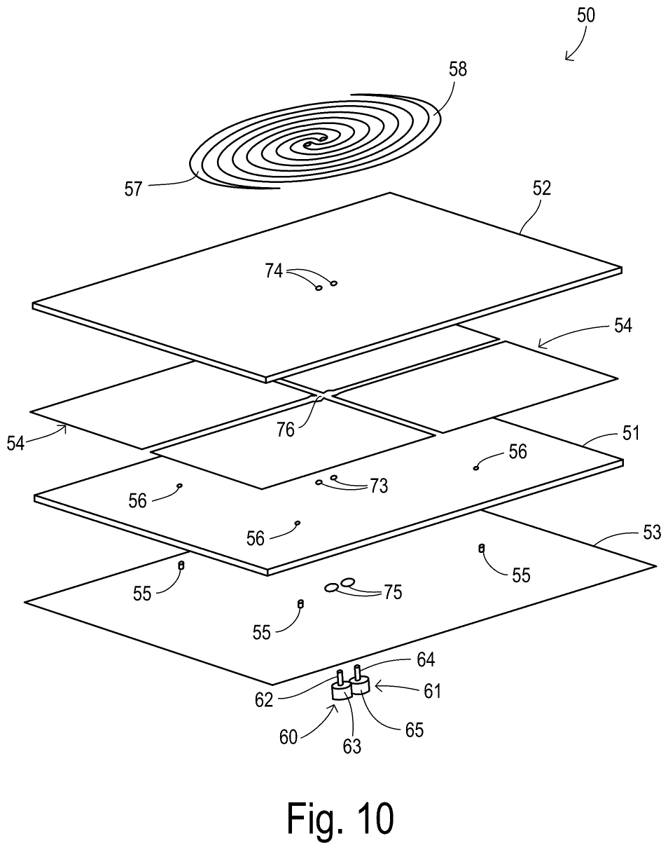

FIGS. 10-17 depict a conformal antenna adapted to receive RF signals for a global navigation satellite system, such as GPS LI signals at 1575.42 MHz. Similar to the previous embodiments, the GNSS antenna employs a meta-material which is a dielectric board with one side completely metalized and acting as the ground plane and the other side having a periodic array of square patches. Moreover, the meta-material structures are configured to provide a high impedance surface that suppresses RF currents over a frequency band and which avoids any 180° phase flip in reflections, such that the GPS or other GNSS signals of interest are selected. The size and shape of patches, the size and shape of vias, and thickness of dielectric substrates are all designed to resonate at the frequency of interest (e.g., 1.5 GHZ).

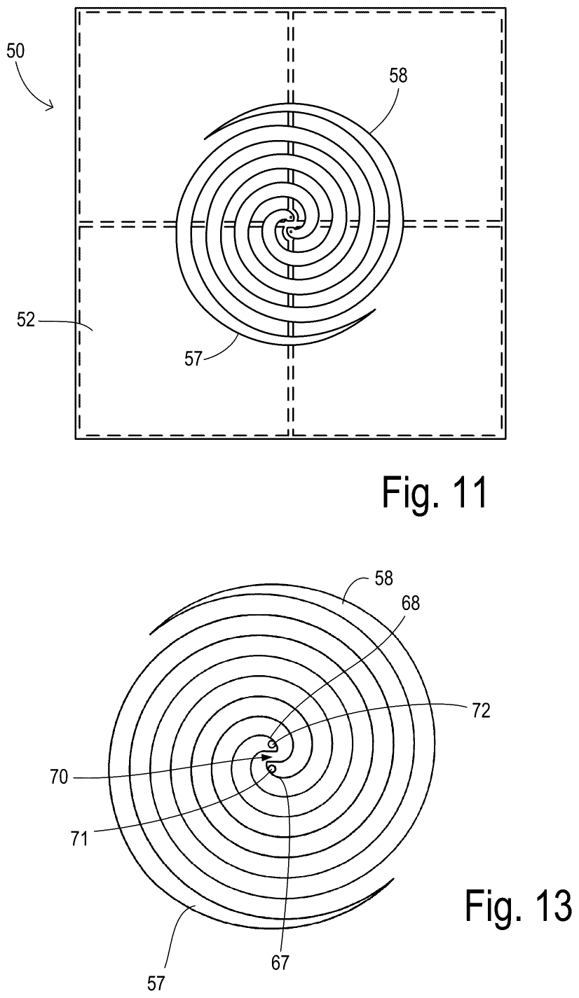

In FIG. 10, a laminated antenna structure 50 is shown in exploded view to reveal a first substrate 51 and a second substrate 52 which is juxtaposed on first substrate 51. A conductive ground plane layer 53 is provided on a lower surface of first substrate 51. A plurality of conductive patches 54 form an array between substrates 51 and 52. Patches 54 are preferably disposed on (e.g., deposited on) an upper surface of first dielectric substrate 51, but may alternatively be disposed on a lower surface of second substrate 52. A plurality of conductive vias 55 extend through holes 56 in first dielectric substrate 51, each connecting a respective one of conductive patches 54 to ground plane layer 53. Second dielectric substrate 52 rests against the upper surface of first substrate 51, with patches 54 between the substrates. Spiral antenna elements 57 and 58 are disposed on an upper surface of second dielectric substrate 52. As shown by the top view of antenna 50 in FIG. 11, spiral antenna elements 57 and 58 are fully encompassed within footprints of conductive patches 54 and ground plane layer 53 to ensure operation as a meta-material structure.

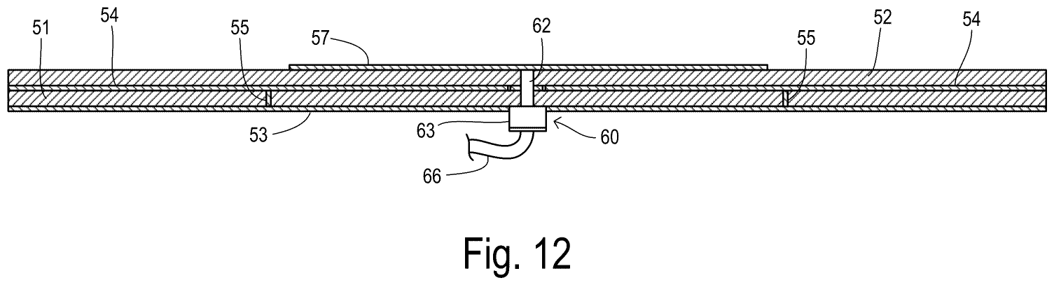

A pair of coaxial connector bodies 60 and 61 have respective signal conductors 62 and 64 for connecting to spiral antenna elements 57 and 58, respectively, at their origination (i.e., inner) ends. FIG. 13 shows origination ends 67 and 68 of elements 57 and 58 which are separated by a gap 70. Origination ends 67 and 68 have openings 71 and 72 providing solder points for connecting to signal conductors 62 and 64, respectively. First dielectric substrate 51 has holes 73 for passing signal conductors 62 and 64, and second dielectric substrate 52 has holes 74 for passing signal conductors 62 and 64. Ground plane layer 53 has openings 75 for passing signal conductors 62 and 64, and patches 54 define a figure-8 opening 76 for passing signal conductors 62 and 64. Coaxial conductor bodies 60 and 61 have respective outer shield conductors 63 and 65 (insulated from signal conductors 62 and 64) which are connected to ground plane layer 53. Coaxial connector bodies 60 and 61 provide respective transmission lines coupled to origination ends 67 and 68, respectively, to conduct received GNSS signals to an RF receiver. Coaxial cables may be mounted to the coaxial connector bodies to extend the transmission lines to the receiver. As shown in FIG. 12, a coaxial cable 66 is connected to connector body 60 to route the received RF signals to the RF receiver (not shown).

As shown in FIG. 13, antenna elements 57 and 58 conform to a two-arm Archimedean spiral. Each arm extends for more than about one turn, and preferably about two turns. The expansion coefficient of the spiral may be about 2.3. Gap 70 between origination ends 67 and 68 may be about 0.05 inches. Openings 71 and 72 may be about 0.025 inches in radius to accommodate signal conductors 62 and 64.

A two-arm Archimedean spiral may also be used for reception of SDARS signals. One skilled in the art can adjust dimensions of the antenna structures for performance at around 2.3 GHZ. Furthermore, a different number of arms can be used, the arms may have greater or fewer turns, and the arms can rotate either clockwise or counterclockwise.

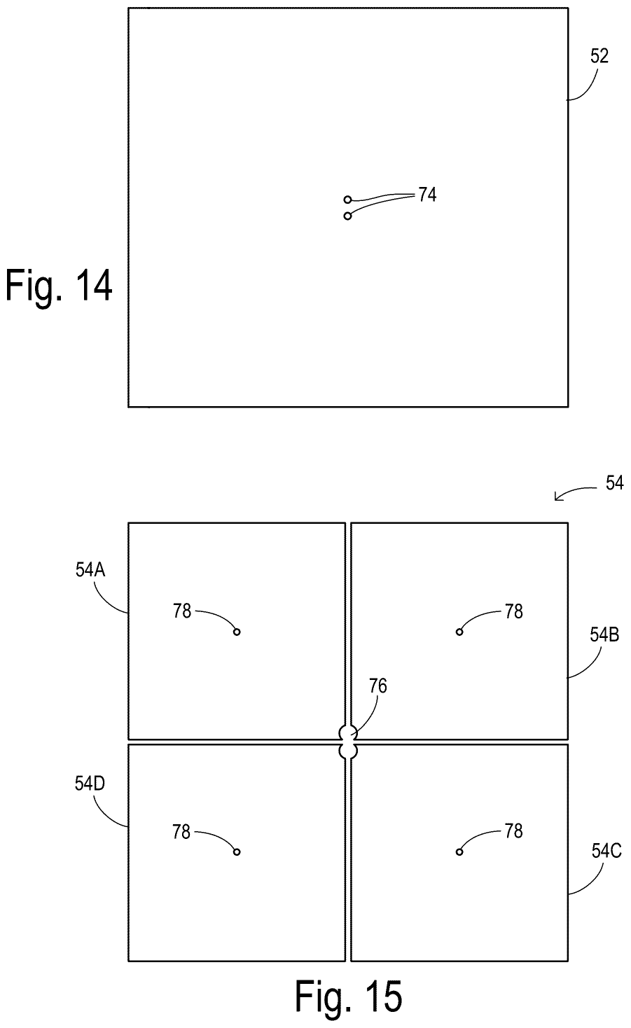

Spiral antenna elements 57 and 58 are formed on a top surface of second dielectric substrate 52 for which FIG. 14 shows a top view. Second dielectric substrate 52 may be about 4.25 inches square and about 0.062 inches thick in the present example for GNSS reception. A Rogers RT/Duroid® 5880 laminate can be used. Substrate 52 includes holes 74 which may have a radius of 0.025 inches to convey signal conductors 62 and 64 so they may be connected (e.g., soldered) to spiral antenna elements 57 and 58 at openings 71 and 72. The centers of holes 74 may be separated by about 0.17 inches.

FIG. 15 is a top view of conductive patches 54A-54D which are preferably formed on a top surface of first dielectric substrate 51. Each patch 54A-54D is generally square in shape with sides of about 2.075 inches, and there is a gap between adjacent patches of greater than or equal to 0.04 inches, preferably about 0.05 inches. For a GNSS application, each side may be between about one inch and three inches. Conductive vias 55 from ground plane layer 53 join with patches 54A-54D at connection points 78 at the center of each patch. Adjacent corners of patches 54A-54D have semi-circular cutouts to define opening 76 where signal conductors 62 and 64 are conveyed. Opening 76 may have a figure-8 shape to correspond to openings 75 in ground plane layer 53.

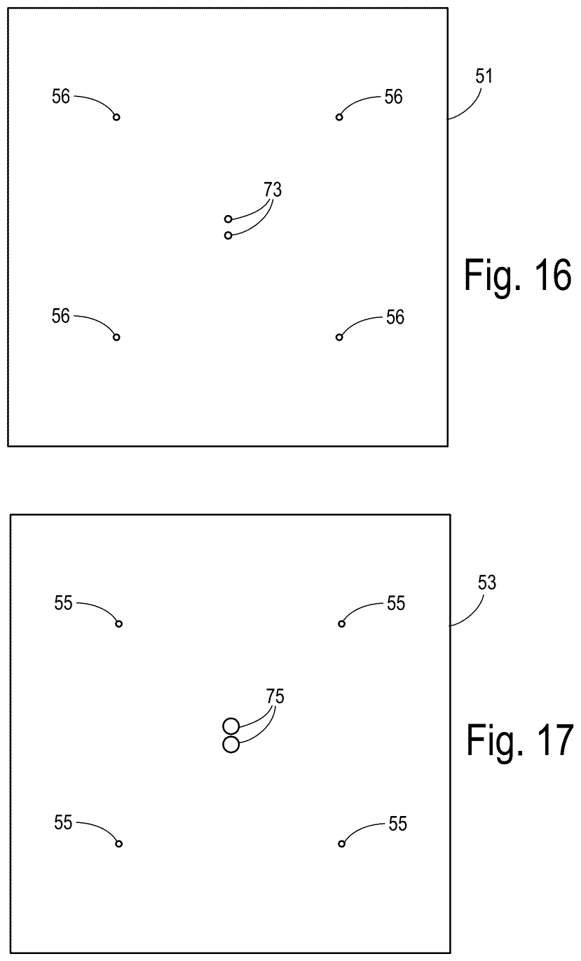

FIG. 16 shows a top surface of first dielectric substrate 51 which may also comprise a Rogers RT/Duroid® 5880 laminate about 4.25 inches square and having a thickness less than or equal to 0.01 inches, preferably about 0.062 inches thick. Conductive vias 55 are cylindrical conductors which pass through openings 56 in substrate 51 to link conductive patches 54A-54D with ground plane layer 53. The radius of vias 55 may be in a range of about 0.01 to 0.15 inches, most preferably about 0.01 inches. Holes 73 in substrate 51 may have a radius of about 0.05 inches and may have their centers separated by about 0.17 inches.

Ground plane layer 53, shown in a top view in FIG. 17, may be formed on a bottom surface of substrate 51. Openings 75 may each have a radius of about 0.081 inches to accommodate coaxial connector bodies 60 and 61, which may have their outer shield conductors connected to ground plane layer 53 along the edges of openings 75.

What is claimed is:

1. An antenna conformal to a vehicular surface, comprising:
a first dielectric substrate having a conductive ground plane layer on a lower surface of the first dielectric substrate;
a second dielectric substrate juxtaposed with an upper surface of the first dielectric substrate, wherein first and second spiral antenna elements are interposed on an upper surface of the second dielectric substrate, wherein the first and second spiral antenna elements each have respective origination ends separated by a gap;
a plurality of conductive patches disposed in an array on at least one of the first dielectric substrate or the second dielectric substrate between the upper surface of the first dielectric substrate and a lower surface of the second dielectric substrate;
a plurality of conductive vias through the first dielectric substrate connecting the conductive patches to the ground plane layer; and
first and second RF transmission lines respectively coupled to the origination ends.

2. The antenna of claim 1 wherein the first and second RF transmission lines are comprised of first and second coaxial connector bodies, respectively.

3. The antenna of claim 2 wherein the first and second coaxial connector bodies each include an outer shield conductor connected to the ground plane layer and an inner conductor connected to the respective origination ends.

4. The antenna of claim 1 wherein the first and second spiral antenna elements trace first and second arms of a two-arm Archimedean spiral, respectively, and wherein each of the first and second spiral antenna elements has greater than one turn.

5. The antenna of claim 1 wherein the ground plane layer, a thickness of the first dielectric substrate, a size of each of the conductive patches, and a gap distance between adjacent ones of the conductive patches are configured to form a meta-material body which is resonant in a frequency band for a satellite system.

6. The antenna of claim 5 wherein the satellite system is a GNSS or an SDARS.

7. The antenna of claim 5 wherein the conductive patches are substantially square in a two-by-two array, wherein each side of the conductive patches has a length between one inch and three inches, wherein gaps between adjacent conductive patches in the array are each greater than or equal to 0.04 inches, and wherein a thickness of the first dielectric substrate is less than or equal to 0.01 inches.

8. The antenna of claim 7 wherein the conductive vias each comprise a cylindrical conductor member having a radius in a range of 0.01 to 0.15 inches, and wherein each via connects to a respective conductive patch at a geometric center of the respective conductive patch.

9. The antenna of claim 1 further comprising an adhesive backing layer configured to conformally mount the antenna onto the vehicular surface.

10. An antenna conformal to a vehicle for satellite communication, comprising:
a first dielectric substrate having a conductive ground plane layer on a lower surface of the first dielectric substrate;
a second dielectric substrate juxtaposed with an upper surface of the first dielectric substrate, wherein first and second spiral antenna elements are interposed on an upper surface of the second dielectric substrate, wherein the first and second spiral antenna elements each have respective origination ends separated by a gap;
a plurality of conductive patches disposed in an array on at least one of the first dielectric substrate or the second dielectric substrate between the upper surface of the first dielectric substrate and a lower surface of the second dielectric substrate;
a plurality of conductive vias through the first dielectric substrate connecting the conductive patches to the ground plane layer;
first and second RF transmission lines respectively coupled to the origination ends; and
an overwrap covering the first and second substrates and configured to mount onto an exterior surface of the vehicle.

11. The antenna of claim 10 wherein the first and second RF transmission lines are comprised of first and second coaxial connector bodies, respectively.

12. The antenna of claim 11 wherein the first and second coaxial connector bodies each include an outer shield conductor connected to the ground plane layer and an inner conductor connected to the respective origination ends.

13. The antenna of claim 10 wherein the first and second spiral antenna elements trace first and second arms of a two-arm Archimedean spiral, respectively, and wherein each of the first and second spiral antenna elements has greater than one turn.

14. The antenna of claim 10 wherein the ground plane layer, a thickness of the first dielectric substrate, a size of each of the conductive patches, and a gap distance between adjacent ones of the conductive patches are configured to form a meta-material body which is resonant in a frequency band for a satellite system.

15. The antenna of claim 14 wherein the satellite system is a GNSS or an SDARS.

16. The antenna of claim 14 wherein the conductive patches are substantially square in a two-by-two array, wherein each side of the conductive patches has a length between one inch and three inches, wherein gaps between adjacent conductive patches in the array are each greater than or equal to 0.04 inches, and wherein a thickness of the first dielectric substrate is less than or equal to 0.01 inches.

17. The antenna of claim 16 wherein the conductive vias each comprise a cylindrical conductor member having a radius in a range of 0.01 to 0.15 inches, and wherein each via connects to a respective conductive patch at a geometric center of the respective conductive patch.

18. The antenna of claim 10 further comprising an adhesive backing layer configured to conformally mount the antenna onto the exterior surface of the vehicle.
